(19) United States
(12) Patent Application Publication
(10) Pub. No.: US 2007/0136130 A1
(43) Pub. Date: Jun. 14, 2007

(54) Interactive multimedia push system and method of operating the same

(75) Inventors: Chih-Yuan Liu, Hsinchu County (TW); Wei-Cheng Tseng, Chiayi County (TW); Fu-Kuei Chang, Kaohsiung City (TW)

Correspondence Address: AKIN GUMP STRAUSS HAUER & FELD L.L.P., ONE COMMERCE SQUARE, 2005 MARKET STREET, SUITE 2200, PHILADELPHIA, PA, 19103, US

(73) Assignee: Industrial Technology Research Institute

(21) Appl. No.: 11/302,891

(22) Filed: Dec. 14, 2005

(51) Int. Cl. G06Q 30/00

(52) U.S. Cl. 705/14

(57) ABSTRACT

A communication device for interactive advertising includes a first interface for communicating with a server receiving from the server a media presentation of a product including purchase information of the product retrievable by a portable device, and a second interface for communicating with the portable device displaying the media presentation including the purchase information to enable purchase of the product through the portable device.

### BACKGROUND OF THE INVENTION

The present invention relates generally to a system and method for delivering advertising information, and more particularly, to a system and method for interactive advertising.

In many stores such as wholesale stores, chain stores and department stores, static and dynamic advertising materials are usually delivered or broadcast to customers to attract public attention. The static advertising materials may often include posters, billboards, flyers, brochures and handouts, while the dynamic advertising materials include media presentation broadcast via television, radio and video tape. Such kinds of advertising, however, have been found not very effective.

Generally, the clients of the server display advertising materials in accordance with a play list scheduled by the server at a predetermined period of time in a predetermined sequence. However, due to physical limits like the screen size of display devices and the play length of the advertising materials, important information, in particular, detailed purchase information to enable a customer to purchase a product, is generally not displayed in the advertising materials.

It is desirable to provide a system and method that allow a user to interact with the media presentation to facilitate the interchange of important information and purchase activities.

### BRIEF SUMMARY OF THE INVENTION

The present invention is directed to a system and method for interactive advertising that obviates one or more problems resulting from the limitations and disadvantages of the prior art.

In accordance with an embodiment of the present invention, there is provided a communication device for interactive advertising that comprises a first interface for communicating with a server and receiving from the server a media presentation of a product including purchase information of the product retrievable by a portable device, and a second interface for communicating with the portable device and displaying the media presentation including the purchase information to enable purchase of the product through the portable device.

Also in accordance with the present invention, there is provided a communication device for interactive advertising that comprises a first interface for communicating with a server and receiving from the server a media presentation of a product including a machine-retrievable image of the product retrievable by a portable device, and a second interface for communicating with the portable device and displaying the machine-retrievable image during display of the media presentation to enable purchase of the product through the portable device.

Further in accordance with the present invention, there is provided a communication device for interactive advertising that comprises a first interface for communicating with a server and receiving from the server a media presentation of a product including purchase information of the product retrievable by a portable device, and a second interface for communicating with the portable device and transmitting the purchase information to the portable device over a radio channel during display of the media presentation to enable purchase of the product through the portable device.

Still in accordance with the present invention, there is provided a communication device for interactive advertising that comprises a first interface for communicating with a server and receiving from the server a media presentation of a product including purchase information of the product, and a second interface for communicating with the portable device and receiving a contact address from the portable device over a radio channel during display of the media presentation to enable purchase of the product through the portable device.

Yet still in accordance with the present invention, there is provided a system for interactive advertising that comprises at least one communication device, each of the at least one communication device including a first interface for communicating with a server and receiving from the server a media presentation of a product including purchase information of the product retrievable by a portable device, and a second interface for communicating with the portable device and displaying the media presentation including the purchase information to enable purchase of the product through the portable device.

Further in accordance with the present invention, there is provided a method for interactive advertising that comprises communicating with a server, receiving from the server a media presentation of a product including purchase information of the product retrievable by a portable device, communicating with the portable device, and displaying the media presentation including the purchase information to enable purchase of the product through the portable device.

Still in accordance with the present invention, there is provided a method for interactive advertising that comprises providing a media presentation of a product including a machine-retrievable image of the product retrievable by a portable device, broadcasting the media presentation including the machine-retrievable image, and exposing the machine-retrievable image to the portable device during display of the media presentation to enable purchase of the product through the portable device.

Also in accordance with the present invention, there is provided a method for interactive advertising that comprises providing a media presentation of a product including purchase information of the product, broadcasting the media presentation including the purchase information, receiving user information including a contact address of a user of the portable device, and transmitting the purchase information to the contact address to enable purchase of the product through the portable device.

Additional features and advantages of the present invention will be set forth in part in the description which follows, and in part will be obvious from the description, or may be learned by practice of the invention. The features and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

In the drawings:

FIG. 1 is a schematic block diagram of a system for interactive advertising in accordance with one embodiment of the present invention;

FIG. 2 is a schematic block diagram of a system for interactive advertising in accordance with another embodiment of the present invention;

FIG. 3 is a schematic block diagram of a system for interactive advertising in accordance with yet another embodiment of the present invention;

FIG. 4 is a schematic block diagram of a system for interactive advertising in accordance with still another embodiment of the present invention;

FIG. 5 is a flow diagram of a method for interactive advertising in accordance with the one embodiment of the present invention;

FIG. 6 is a flow diagram of a method for interactive advertising in accordance with the another embodiment of the present invention; and

FIG. 7 is a flow diagram of a method for interactive advertising in accordance with the still another embodiment of the present invention.

### DETAILED DESCRIPTION OF THE INVENTION

Reference will now be made in detail to the present embodiments of the invention, examples of which are illustrated in the accompanying drawings. The same reference numbers are used throughout the drawings to refer to the same or like parts.

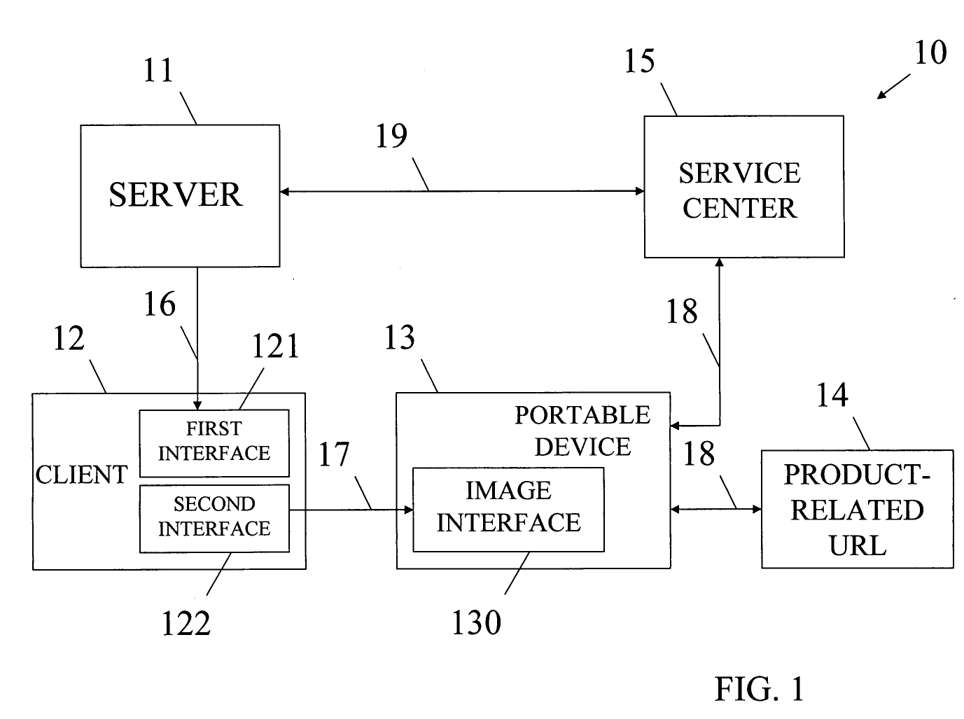

FIG. 1 is a schematic block diagram of a system 10 for interactive advertising in accordance with one embodiment of the present invention. Referring to FIG. 1, the system 10 includes a server 11, at least one client 12 and a portable device 13. The portable device 13, for example, a cellular phone or a personal digital assistant (“PDA”) that supports Internet and networking features, includes an image interface 130 such as a digital camera. Each of the at least one client 12, for example, a computer, includes a first interface 121 for communicating with server 11 and a second interface 122 for communicating with the portable device 13. The first interface 121, for example, an interface network card, communicates with the server 11 over a communication network 16, for example, the Internet. In one embodiment according to the present invention, the first interface 121 receives media files and a play list from the server 11. The second interface 122, for example, a display screen, displays the media files in accordance with the play list. In one embodiment, the second interface 122 displays the purchase information of a product including an image retrievable by the portable device 13.

The system 10 may further include a service center 15, for example, a database computer, at which the product information of a specific product and the user information of a user of the system 10 are accessible. The product information of a product includes but is not limited to the product name, product profiles and, among others, product identification and places of sale of the product. The product information is predetermined before its broadcast and may be updated afterwards if necessary. The user information includes but is not limited to the identification, personal preference and, among others, the network address or phone number of the portable device 13 and a contact address of the user. The user information to be stored in the service center 15 or server 11 is obtained during interactions between a user and the system 10.

In operation, the server 11 retrieves product information including a product identification or places of sale corresponding to a product from the service center 15 over a communication network 19, for example, the Internet. Alternatively, the server 11 generates such product information. The server 11 then determines a machine-retrievable image corresponding to the product identification, for example, a barcode of the product, and combines the machine-retrievable image into a media presentation provided for advertising the product. Subsequently, the media presentation with the machine-retrievable image is transmitted from the server 11 over the communication network 16 to the at least one client 12 for display. According to the present invention, a user who is interested in the product through viewing the media presentation is allowed to obtain information that facilitates purchase activities of the product. Specifically, the image interface 130 of the portable device 13 retrieves the machine-retrievable image currently displayed with the media presentation and analyzes the machine-retrievable image to obtain product information corresponding to the product identification. Since the places of sale are indicated in the product information, the user is able to purchase the product through the portable device 13 on the instant. The user may decide to proceed the purchase over a communication network 18, for example, a wireless network or GSM (Global System for Mobile Communication) in accordance with a URL (Uniform Resource Locator) indicated in the product information, which links to a sale website 14 of the product or the service center 15, where the user is allowed to complete the purchase through a financial transaction. Alternatively, instead of the on-line purchase, the user may decide to proceed the purchase at a physical store nearby.

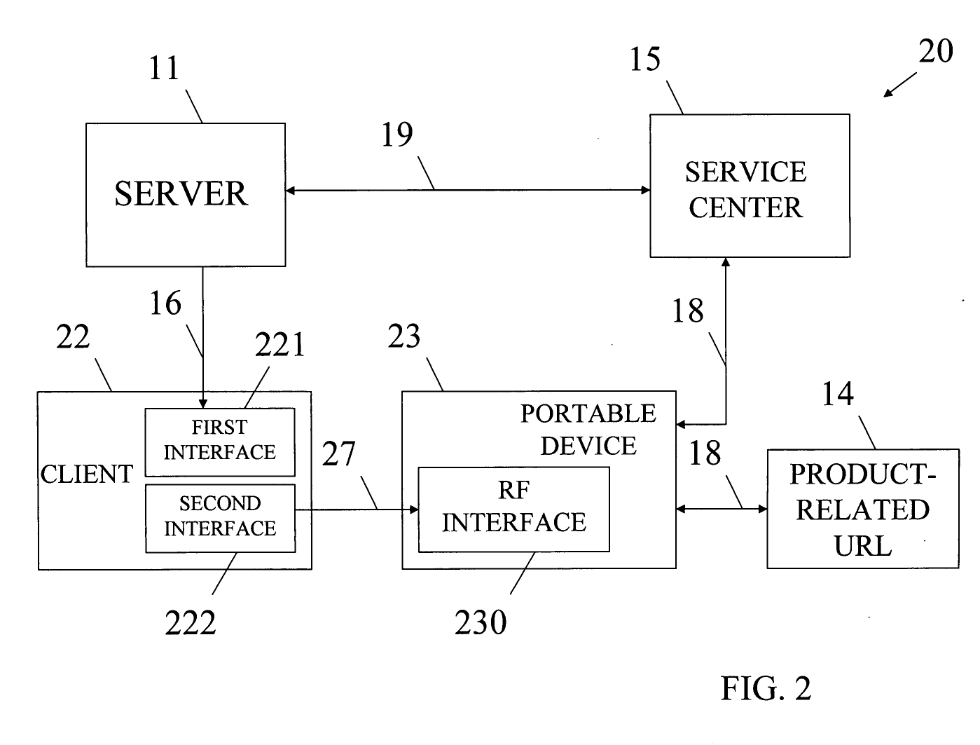

FIG. 2 is a schematic block diagram of a system 20 for interactive advertising in accordance with another embodiment of the present invention. Referring to FIG. 2, the system 20 has a similar structure to the system 10 illustrated in FIG. 1 except for the at least one client 22 and the portable device 23. Each of the at least one client 22 includes a first interface 221 for communicating with server 11 and a second interface 222 for communicating with the portable device 23. The first interface 221 receives media files and a play list from the server 11. The second interface 222, for example, a wireless communication device, transmits the purchase information during display of a media file corresponding to a product. The portable device 23 includes a radio-frequency (“RF”) interface 230 for receiving a product information 220 via an RF channel 27 using a conventional telecommunication technique that supports short-range wireless communications. Examples of the short-range telecommunications technique include but are not limited to an infrared (“IR”), Bluetooth, UWB (Ultra Wide Band), ZigBee, WiMax (Worldwide Interoperability for Microwave Access) and NFC (Near Field Communication) technology. The Bluetooth refers to an industrial specification for wireless personal area networks (“PANs”), which provides a way to connect and exchange information between devices such as PDAs, cellular phones, laptops, personal computers (“PCs”), printers and digital cameras via a globally available short range radio frequency. The UWB refers to a wireless communications technology that support transmission of data at a relatively high speed ranging from approximately 40 to 60 megabits per second and eventually up to 1 gigabit per second. The ZigBee refers to a published specification set of high level communication protocols designed to use small, low power digital radios for wireless personal area networks (“WPANs”). The WiMax refers to a certification mark for products. Products that pass the WiMAX tests are capable of forming wireless connections between them to permit the carrying of internet packet data. The NFC Forum is a non-profit industry association formed to advance the use of NFC short-range wireless interaction in consumer electronics, mobile devices and PCs.

In operation, the server 11 retrieves the product information including the purchase information corresponding to a product from the service center 15 over the communication network 19. Alternatively, the server 11 itself generates the product information. The first interface 221 of the at least one client 22 receives the product information from the server 11 over the communication network 16 for display with a media presentation. A user attracted by the media presentation is allowed to obtain information that facilitates follow-up purchase activities through the portable device 23. Specifically, the RF interface 230 of the portable device 23 retrieves the product information including the places of sale, which enables the user to purchase the product through the portable device 23 on the instant. The user may decide to proceed the purchase over the communication network 18 in accordance with a URL indicated in the product information, which links to the sale website 14 of the product or the service center 15, where the user is allowed to complete the purchase through a financial transaction. Alternatively, the user may decide to proceed the purchase at a physical store.

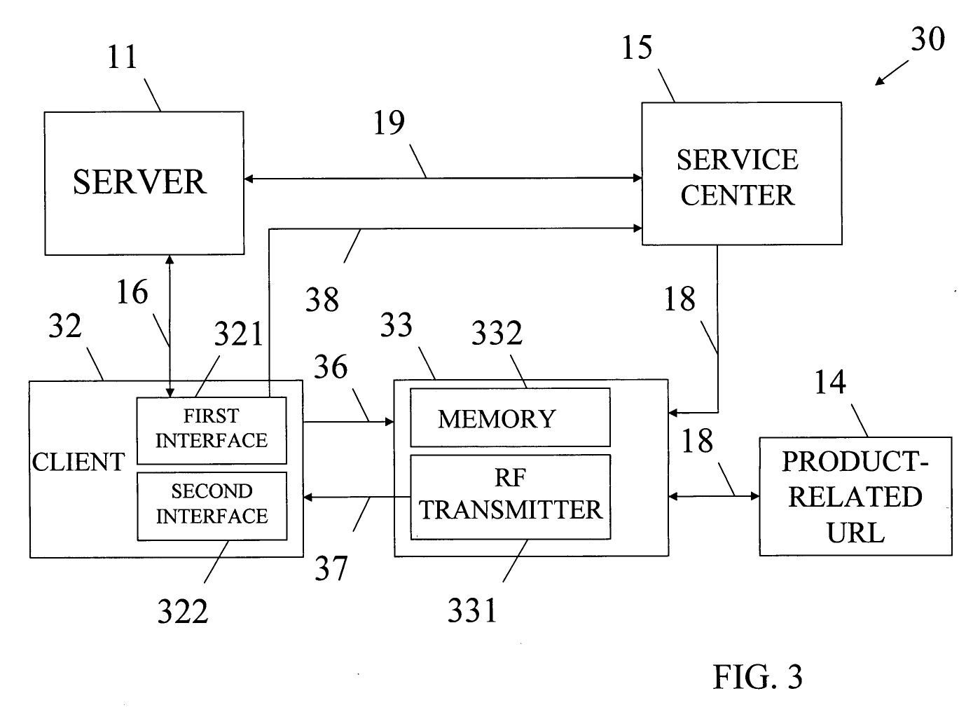

FIG. 3 is a schematic block diagram of a system 30 for interactive advertising in accordance with yet another embodiment of the present invention. Referring to FIG. 3, the system 30 has a similar structure to the system 10 illustrated in FIG. 1 except for the at least one client 32 and the portable device 33. Each of the at least one client 32 includes a first interface 321 for communicating with server 11 and a second interface 322 for communicating with the portable device 33. The first interface 321 receives media files and a play list from the server 11 over the communication network 16. The second interface 322, for example, a wireless communication device, receives the user information stored in the portable device 33 over an RF channel 37. The portable device 33 includes a memory 332 for storing the user information of a user of the portable device 33, and a transmitter 331 for transmitting the user information. The traffic between the at least one client 32 and the portable device 33 may be implemented using a conventional NFC or RFID (Radio Frequency IDentification) technique, which supports a short-range data communication. The RFID refers to an automatic identification method based on storing and remotely retrieving data using devices called RFID tags. The memory 332 includes but is not limited to a memory card, RFID card, NFC card, contact card or contactless card.

In operation, the server 11 retrieves the product information corresponding to a product from the service center 15 over the communication network 19, and transmits the product information over the communication network 16 to the at least one client 32 for display with a media presentation provided for advertising the product. A user using the portable device 33 proximate to the at least one client 32 is allowed to provide the user's information to the at least one client 32 in order to facilitate purchase activities. In response to the user information received, the at least one client 32 transmits the product information to the portable device 33 over a short-range communication network 36, for example a conventional NFC.

Alternatively, the at least one client 32 transmits the user information via the server 11 over the communication network 16 to the service center 15, which in turn transmits the production information over the communication network 18 to a contact address indicated in the user information. Alternatively, the one client 32 transmits the user information over a communication network 38, for example, the Internet to the service center 15, which in turn transmits the product information to the contact address. The contact address includes but is not limited to a phone number of the portable device 33, an e-mail address or a network address of the portable device 33. If the contact address is the phone number of the portable device 33, the product information is sent to the portable device 33 by way of an SMS (Short Message Service) or MMS (Multimedia Messaging System) message. The SMS refers to a text-only messaging system for mobile networks. The MMS, which is an evolution of the SMS, refers to a system of transmitting not only text messages, but also various kinds of multimedia contents, for example, images, audio and/or video clips, over wireless networks. If the contact address is an e-mail address, the product information is sent to the e-mail address. Either way, the user may decide to purchase the product over the communication network 18 in accordance with a URL indicated in the product information, which links to the sale website 14 of the product or the service center 15. Alternatively, the user may decide to purchase the product at a physical store. If the contact address is the network address of the portable device 33, the production information is sent to the network address over the Internet.

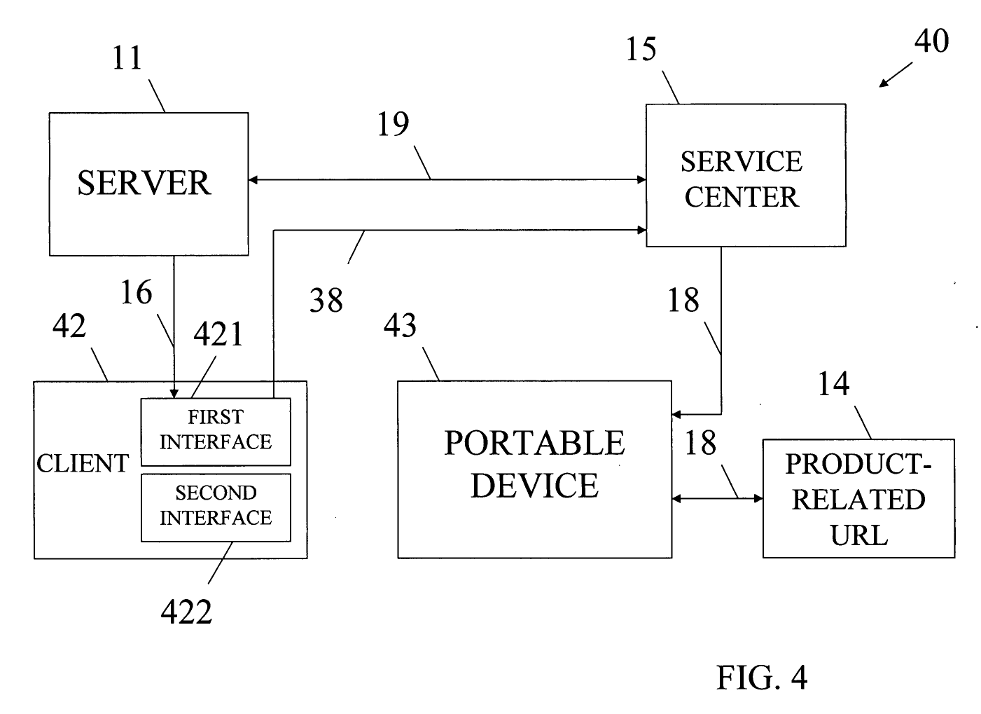

FIG. 4 is a schematic block diagram of a system 40 for interactive advertising in accordance with still another embodiment of the present invention. Referring to FIG. 4, the system 40 has a similar structure to the system 30 illustrated in FIG. 3 except that the at least one client 42 and the portable device 43. Each of the at least one client 42 includes a first interface 421 for communicating with server 11 and a second interface 422 for communicating with the portable device 43. The portable device 43 does not support the image processing in the portable device 13 illustrated in FIG. 1 or the RF processing in the portable device 23 and 33 illustrated in FIGS. 2 and 3, respectively. The first interface 421 receives media files and a play list from the server 11 over the communication network 16. The second interface 422, for example, an input/output (“I/O”) device, allows a user of the portable device 43 to enter the phone number of the portable device 43.

In operation, the first interface 421 of one of the at least one client 42 at which the phone number is input transmits the phone number via the server 11 over the communication network 16 to the service center 15, which in turn transmits an SMS or MMS message including the product information to the portable device 43 at the phone number. Alternatively, the first interface 421 of the one client 42 transmits the phone number over the communication network 38 to the service center 15, which in turn transmits an SMS or MMS message including the product information to the portable device 43. The user may decide to purchase the product over the communication network 18 in accordance with a URL indicated in the product information, which links to the sale website 14 of the product or the service center 15. Alternatively, the user may decide to purchase the product at a physical store.

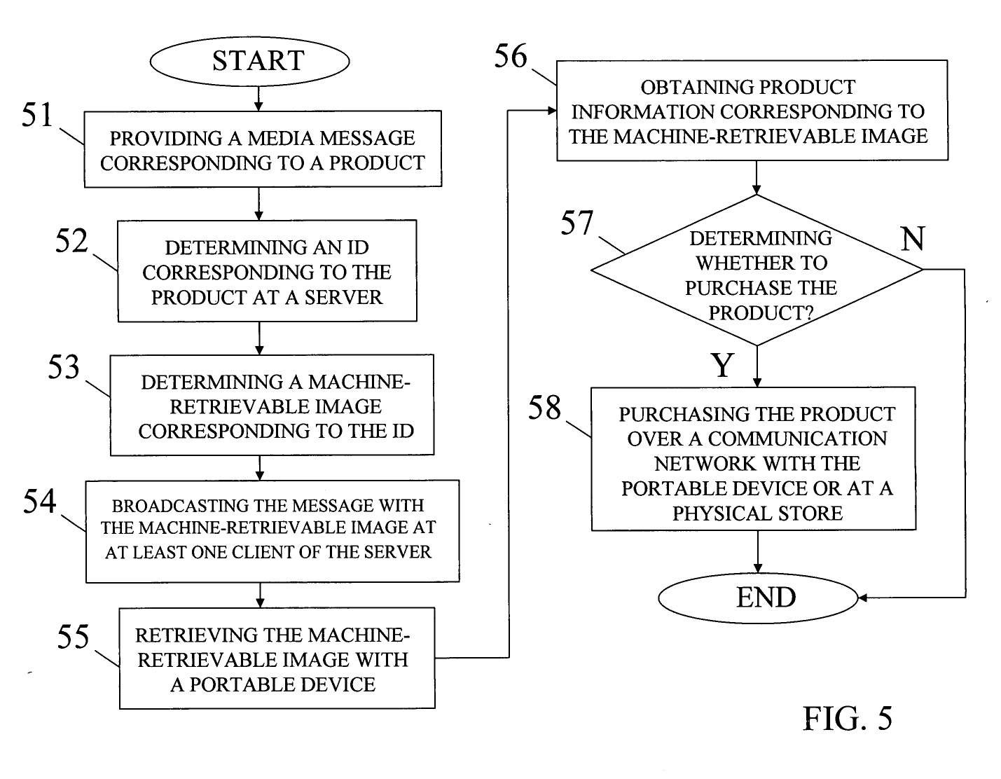

FIG. 5 is a flow diagram of a method for interactive advertising in accordance with the first embodiment of the present invention. Referring to FIG. 5, also referring to FIG. 1, a message such as a media presentation corresponding to a specific product is provided at step 51. At step 52, a product identification (ID) corresponding to the product is determined at the server 11. In one aspect, the product ID is retrieved from the service center 15. In another aspect, the product ID is generated at the server 11. Next, at step 53, a machine-retrievable image such as a barcode is determined and combined with the media message at the server 11. At step 54, the media message together with the machine-retrievable image is displayed at the least one client 12 of the server 11. A user interested in the message is allowed to retrieve the machine-retrievable image from the media message with a portable device 13 at step 55. Next, at step 56, the machine-retrievable image is analyzed in the portable device to obtain the product information corresponding to the product. The product information includes at least the places of sale, which in turn include a URL that enables the user to uplink to a sale website or to the service center 15 or an address of a physical store. At step 57, the user determines whether to purchase the product being advertised. At step 58, the user may decide to purchase the product at a sale website through the portable device 13 or at a physical store.

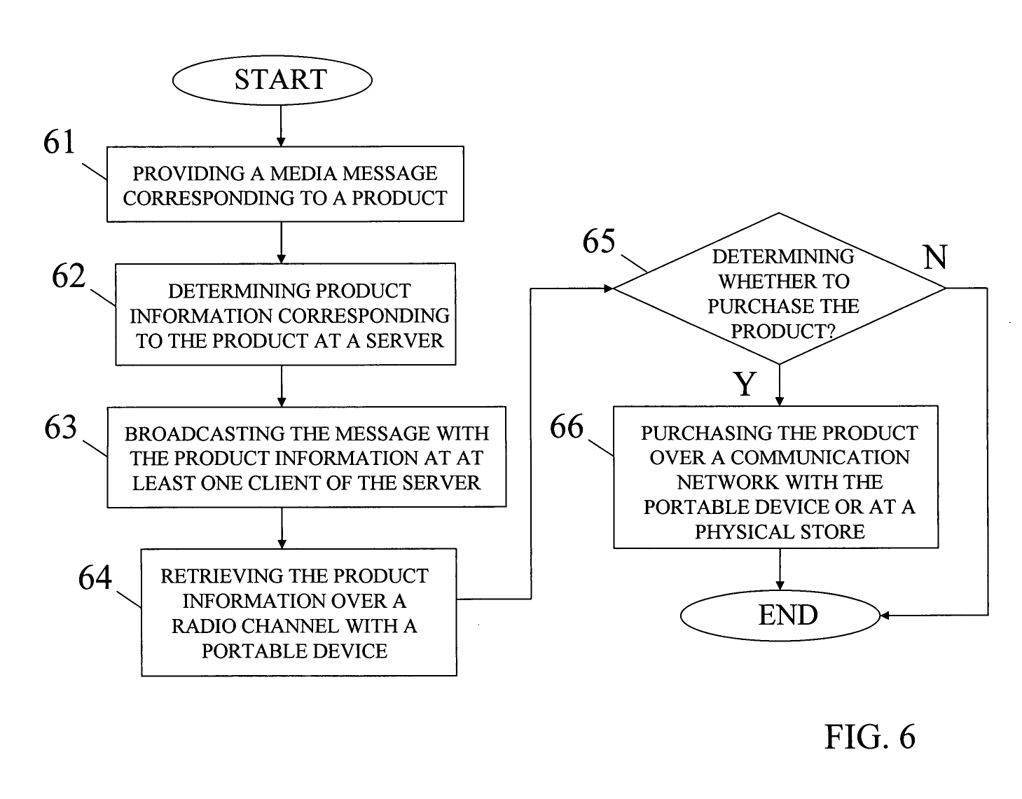

FIG. 6 is a flow diagram of a method for interactive advertising in accordance with another embodiment of the present invention. Referring to FIG. 6, also referring to FIG. 2, at step 61, a message such as a media presentation corresponding to a specific product is provided. At step 62, the product information corresponding to the product is determined at the server 11. In one aspect, the product information is retrieved from the service center 15. In another aspect, the product information is provided by the server 11. At step 63, the media message and the production information is broadcast at the at least one client 16 of the server 11. Next, at step 64, a user interested in the message is allowed to retrieve the product information with a portable device. If the user decides to purchase the product at step 65, he or she may choose a sale website through the portable device or a physical store for the purchase at step 66.

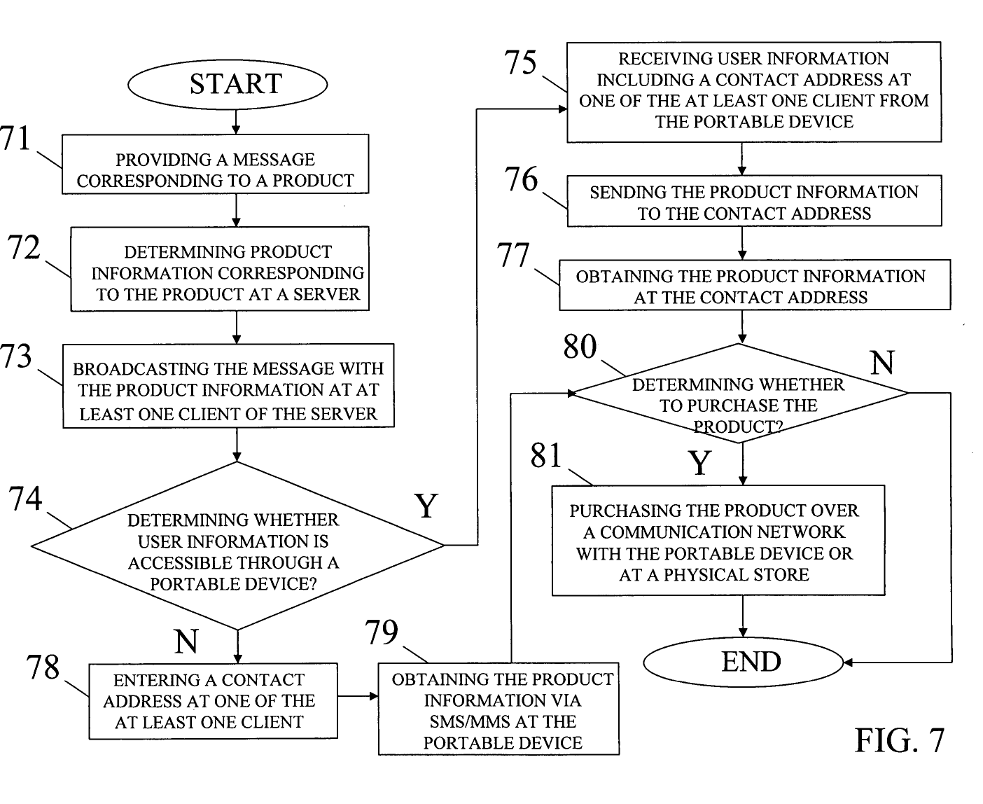

FIG. 7 is a flow diagram of a method for interactive advertising in accordance with still another embodiment of the present invention. Referring to FIG. 7, also referring to FIG. 3, at step 71, a media message corresponding to a product is provided. The product information corresponding to the product is determined at step 72 and broadcast together with the media message at at least one client 32 of a server 11 at step 73. Next, at step 74, it is determined whether the user information of a user is accessible through the portable device 33 at the at least one client 32. If the user information is accessible, at step 75, the user information including a contact address is retrieved at the at least one client 32. Next, at step 76, the product information is sent to the contact address, which includes one of a phone number of the portable device, an e-mail address or a network address of the portable device 33. If at step 74 it is determined that the user information is not accessible from the portable device, at step 78, the user inputs the phone number of the portable device 33 at the at least one client 32. An SMS or MMS message including the product information is later sent to the portable device at step 79. Subsequently, if the user decides to purchase the product at step 80, he or she may choose a sale website through the portable device 33 or at a physical store for the purchase at step 81.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

We claims:

1. A communication device for interactive advertising, comprising:
a first interface for communicating with a server and receiving from the server a media presentation of a product including purchase information of the product retrievable by a portable device; and
a second interface for communicating with the portable device and displaying the media presentation including the purchase information to enable purchase of the product through the portable device.

2. The communication device of claim 1, wherein the second interface includes one of a display device or a wireless communication device.

3. The communication device of claim 2, wherein the wireless communication device supports one of an infrared (“IR”), Bluetooth, UWB (Ultra Wide Band), ZigBee, WiMax (Worldwide Interoperability for Microwave Access) and NFC (Near Field Communication) communication.

4. The communication device of claim 1, wherein the purchase information includes a machine-retrievable image.

5. The communication device of claim 1, wherein the purchase information includes a barcode of the product.

6. The communication device of claim 1, wherein the purchase information indicates a Uniform Resource Locator (URL).

7. The communication device of claim 1, wherein the purchase information is retrievable by a receiver of the portable device over a radio channel.

8. The communication device of claim 1, wherein the second interface is adapted to receiving a contact address of a user transmitted from the portable device over a radio channel.

9. The communication device of claim 8, wherein the contact address is stored in a memory device of the portable device.

10. The communication device of claim 9, wherein the memory device includes one of an RFID (Radio Frequency IDentification) card or an NFC (Near Field Communication) card.

11. The communication device of claim 1, wherein the second interface includes an input/output (“I/O”) device for input of a phone number of the portable device.

12. A communication device for interactive advertising, comprising:
a first interface for communicating with a server and receiving from the server a media presentation of a product including a machine-retrievable image of the product retrievable by a portable device; and
a second interface for communicating with the portable device and displaying the machine-retrievable image during display of the media presentation to enable purchase of the product through the portable device.

13. The communication device of claim 12, wherein the machine-retrievable image includes a barcode of the product.

14. The communication device of claim 12, wherein the machine-retrievable image indicates a URL.

15. The communication device of claim 12, wherein the machine-retrievable image is retrieved by an optical device of the portable device.

16. A communication device for interactive advertising, comprising:
a first interface for communicating with a server and receiving from the server a media presentation of a product including purchase information of the product retrievable by a portable device; and
a second interface for communicating with the portable device and transmitting the purchase information to the portable device over a radio channel during display of the media presentation to enable purchase of the product through the portable device.

17. The communication device of claim 16, wherein the second interface includes one of an infrared (“IR”), Bluetooth, UWB (Ultra Wide Band), ZigBee, WiMax (Worldwide Interoperability for Microwave Access) and NFC (Near Field Communication) device.

18. A communication device for interactive advertising, comprising:
a first interface for communicating with a server and receiving from the server a media presentation of a product including purchase information of the product; and
a second interface for communicating with the portable device and receiving a contact address from the portable device over a radio channel during display of the media presentation to enable purchase of the product through the portable device.

19. The communication device of claim 18, wherein the contact address includes one of a phone number, an email address or a network address of the portable device.

20. The communication device of claim 18, wherein the purchase information is sent to the portable device in one of an SMS (Short Message Service) or MMS (Multimedia Messaging System) message.

21. A system for interactive advertising, comprising:
at least one communication device, each of the at least one communication devices including:
a first interface for communicating with a server and receiving from the server a media presentation of a product including purchase information of the product retrievable by a portable device; and
a second interface for communicating with the portable device and displaying the media presentation including the purchase information to enable purchase of the product through the portable device.

22. The system of claim 21, further comprising a service center at which the purchase information is accessible.

23. The system of claim 22, wherein the purchase information indicates a URL of the service center.

24. The system of claim 21, wherein the purchase information includes a barcode of the product.

25. A method for interactive advertising, comprising:
communicating with a server;
receiving from the server a media presentation of a product including purchase information of the product retrievable by a portable device;
communicating with the portable device; and
displaying the media presentation including the purchase information to enable purchase of the product through the portable device.

26. A method for interactive advertising, comprising:
providing a media presentation of a product including a machine-retrievable image of the product retrievable by a portable device;
broadcasting the media presentation including the machine-retrievable image; and
exposing the machine-retrievable image to the portable device during display of the media presentation to enable purchase of the product through the portable device.

27. The method of claim 26, further comprising providing the machine-retrievable image in the form of a barcode.

28. The method of claim 26, further comprising providing a URL in the machine-retrievable image.

29. A method for interactive advertising, comprising:
providing a media presentation of a product including a purchase information of the product retrievable by a portable device;
broadcasting the media presentation including the machine-retrievable image; and
transmitting the purchase information to the portable device over a radio channel during display of the media presentation to enable purchase of the product through the portable device.

30. The method of claim 29, further comprising transmitting the purchase information through one of an infrared (“IR”), Bluetooth, UWB (Ultra Wide Band), ZigBee, WiMax (Worldwide Interoperability for Microwave Access) and NFC (Near Field Communication) device.

31. A method for interactive advertising, comprising:
providing a media presentation of a product including purchase information of the product;
broadcasting the media presentation including the purchase information;
receiving user information including a contact address of a user of the portable device; and
transmitting the purchase information to the contact address to enable purchase of the product through the portable device.

32. The method of claim 31, further comprising sending one of an SMS (Short Message Service) or MMS (Multimedia Messaging System) message including the purchase information.

33. The method of claim 31, further comprising transmitting the purchase information to an email address indicated in the contact address.

34. The method of claim 31, further comprising transmitting the purchase information to a network address indicated in the contact address.

35. The method of claim 31, further comprising receiving a phone number of the portable device entered by the user of the portable device.

36. The method of claim 35, further comprising sending one of an SMS or MMS message including the purchase information to the portable device.
